(19) United States
(12) Patent Application Publication
(10) Pub. No.: US 2023/0222092 A1
(43) Pub. Date: Jul. 13, 2023

(54) METHOD OF MANAGING STORAGE SPACE BASED ON ROBUST DETERMINATIONS OF DURATIONS FOR DELETING SNAPSHOTS

(71) Applicant: VMware, Inc., Palo Alto, CA (US)

(72) Inventors: Enning XIANG, San Jose, CA (US); Wenguang WANG, Santa Clara, CA (US); Subhradyuti SARKAR, Newark, CA (US); Fan NI, Fremont, CA (US)

(21) Appl. No.: 17/575,403

(22) Filed: Jan. 13, 2022

(51) Int. Cl. G06F 16/11; G06F 16/17

(52) U.S. Cl. CPC G06F 16/125; G06F 16/1727

(57) ABSTRACT

A method of managing storage space of a storage device, wherein the storage device includes a plurality of snapshots of a file, includes the steps of: in response to a request to delete a first snapshot, determining a first amount of time that elapsed between a creation of the first snapshot and a creation of a second snapshot that is a child snapshot of the first snapshot: and after determining the first amount of time, executing a first process to delete the first snapshot over a first time interval, wherein the first time interval is based on the first amount of time.

### BACKGROUND

In a virtualized computer system, virtual machines (VMs) execute on hosts, and virtual disks of the VMs are provisioned in a storage device accessible to the hosts as files of the computer system. As the VMs issue write input/output operations (IOs) to the virtual disks, the states of the virtual disks change over time. To preserve the state of a virtual disk at a point in time, a snapshot of the virtual disk is created. After the creation of the snapshot, write IOs issued to data blocks that were allocated to the virtual disk before the creation of the snapshot, result in allocations of new data blocks and data being written to the new data blocks. In this manner, the state of the virtual disk at the time the snapshot was taken is preserved. Over time, a series of snapshots of the virtual disk may be taken, and the state of the virtual disk may be restored to any of the prior states that have been preserved by the snapshots.

As the storage device fills up, snapshots may be targeted for deletion in background processes to free up space in the storage device. However, processing snapshot deletion even in the background consumes 10 bandwidth of the computer system and may even create an IO “traffic burst” to cause a sharp drop in the performance of other processes that are also consuming IO bandwidth. To avoid the traffic burst, the processing of snapshot deletion is spread out over a large time interval. However, if the time interval is too large, this will delay the freeing up of storage space resulting from the snapshot deletions. Consequently, storage systems have been developed that distribute the processing of snapshot deletions in such a manner as to strike a balance between freeing up storage space and avoiding traffic burst.

### SUMMARY

Accordingly, one or more embodiments provide a method of managing storage space of a storage device, wherein the storage device includes a plurality of snapshots of a file. The method includes the steps of: in response to a request to delete a first snapshot, determining a first amount of time that elapsed between a creation of the first snapshot and a creation of a second snapshot that is a child snapshot of the first snapshot; and after determining the first amount of time, executing a first process to delete the first snapshot over a first time interval, wherein the first time interval is based on the first amount of time.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computer system in which embodiments may be implemented.

FIGS. 2A-2B illustrate a timeline of periodically creating snapshots of a virtual disk and deleting a snapshot.

FIGS. 3A-3C illustrate a timeline of creating snapshots of a virtual disk ad hoc and deleting snapshots.

FIG. 4 is a flow diagram of steps carried out by a snapshot module to carry out a method of deleting a snapshot of a virtual disk based on a determined duration, according to an embodiment.

### DETAILED DESCRIPTION

Techniques for managing storage space of a storage device based on robust determinations of durations for deleting snapshots are described. According to embodiments, a “running point” of a virtual disk is established when the virtual disk is created, the running point representing the virtual disk’s current state. The running point is then re-established each time a snapshot is created, the current running point becoming the new snapshot, and a new running point becoming the new snapshot’s child. A running point “owns” any data blocks that have been allocated to the virtual disk since the running point was established, such data blocks including data written in response to write IOs and including various metadata that is persisted in the storage device.

In response to a write IO, data blocks may be allocated to the virtual disk for two reasons: (1) the write IO targets a free data block, or (2) the write IO targets a data block that is owned by a snapshot, such a write IO also referred to herein as an “overwrite request.” In response to an overwrite request targeting a data block owned by a snapshot, data is not written directly to the targeted data block because the targeted data block has been designated read-only to preserve its contents. Instead, the contents of the targeted data block are copied to a new data block, the new data block is allocated to the virtual disk, and the overwrite request is performed on the newly allocated data block. Furthermore, the targeted data block becomes inaccessible to the running point. As such, if the targeted data block is owned by the parent snapshot of the running point, the data block becomes “exclusively owned” by the parent snapshot, i.e., the only state of the virtual disk at which the data block is accessible is that captured by the parent snapshot.

When a snapshot is deleted, any exclusively owned data blocks of the snapshot can be freed. The process of deleting the snapshot requires updating of the metadata which is persisted in the storage device. To avoid IO traffic burst, the amount of time that is spent on deleting a snapshot should increase as the amount of the snapshot’s exclusively owned data blocks increases. Furthermore, as discussed above, when a snapshot is a parent snapshot of the running point, data blocks of the snapshot may become exclusively owned due to overwrite requests. As such, according to embodiments, the time interval for deleting a snapshot, i.e., the “ideal duration,” is estimated based on the amount of time that its child snapshot was a running point, i.e., based on its child snapshot’s “active lifespan.” For example, having a child snapshot with a long active lifespan is likely indicative of having a large number of exclusively owned data blocks because of the large amount of time for overwrite requests to have been made, while having a child snapshot with a short active lifespan is likely indicative of having a small number of exclusively owned data blocks.

These and further aspects of the invention are discussed below with respect to the drawings. In addition, although embodiments are discussed with reference to virtual disks, the embodiments are also applicable to snapshots of other types of files.

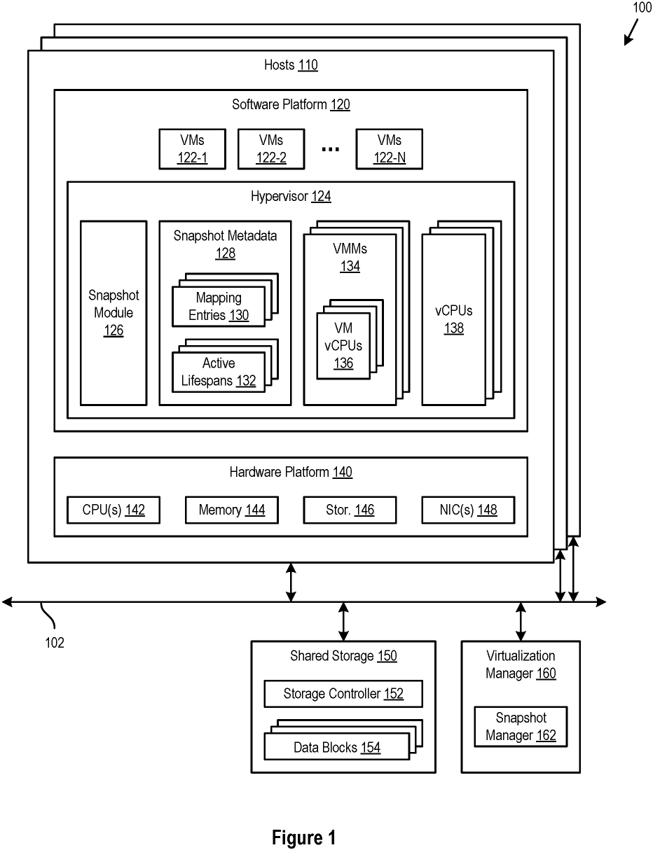

FIG. 1 is a block diagram of a virtualized computer system 100 in which embodiments may be implemented. Virtualized computer system 100 includes a cluster of hosts 110, shared storage 150, and a virtualization manager 160.

Each host 110 is constructed on a server grade hardware platform 140 such as an x86 architecture platform. Hardware platform 140 includes conventional components of a computing device, such as one or more central processing units (CPUs) 142, system memory 144 such as random-access memory (RAM), optional local storage 146 such as one or more hard disk drives (HDDs) or solid-state drives (SSDs), and one or more network interface cards (NICs) 148. CPU(s) 142 are configured to execute instructions such as executable instructions that perform one or more operations described herein, which may be stored in system memory 144. NIC(s) 148 enable hosts 110 to communicate with each other and with other devices over a physical network 102.

Each hardware platform 140 supports a software platform 120. Software platform 120 includes a hypervisor 124, which is a virtualization software layer that abstracts hardware resources of hardware platform 140 for concurrently running VMs 122. One example of hypervisor 124 that may be used is a VMware ESX® hypervisor by VMware, Inc. Although the disclosure is described with reference to VMs 122, the teachings herein also apply to other types of virtual computing instances such as containers, Docker® containers, data compute nodes, isolated user space instances, and the like, for which snapshots are managed. Hypervisor 124 includes a snapshot module 126, various snapshot metadata 128, virtual machine monitors (VMMs) 134, and virtual CPUs (vCPUs) 138.

Snapshot module 126 creates, manages, and deletes snapshots of virtual disks for VMs 122. To perform such functionalities, snapshot module 126 manages snapshot metadata 128, which is stored in system memory 144 and persisted in shared storage 150. For example, snapshot metadata 128 includes mapping entries 130 for snapshots and running points, between addresses of virtual blocks in virtual storage spaces of VMs 122 and physical addresses of data blocks 154 in shared storage 150. Snapshot metadata 128 further includes parent-child relationships among snapshots and running points (not shown) and an active lifespan variable 132 for each snapshot. Active lifespan variables 132 store the active lifespans for corresponding snapshots, i.e., the amounts of the time during which corresponding snapshots were the running points of virtual disks.

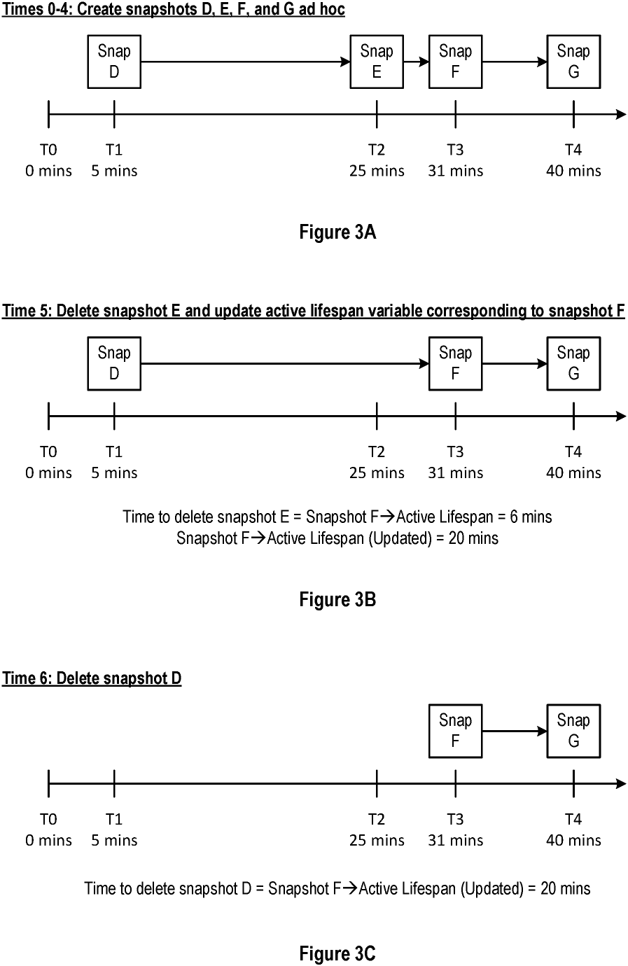

When a snapshot is targeted for deletion, snapshot module 126 determines an ideal duration for deleting the targeted snapshot based on active lifespan variable 132 corresponding to its child snapshot or, if the targeted snapshot does not have a child snapshot, active lifespan variable 132 corresponding to the targeted snapshot. For example, the ideal duration may be exactly or approximately equal to the relevant active lifespan. Furthermore, to make such determinations more robust, if active lifespan variable 132 corresponding to the child snapshot is less than that corresponding to the targeted snapshot, snapshot module 126 updates active lifespan variable 132 corresponding to the child snapshot to that of the targeted snapshot, as discussed further below in conjunction with FIG. 3B.

VMMs 134 implement the virtual system support needed to coordinate operations between VMs 122 and hypervisor 124. Each VMM 134 manages a virtual hardware platform for a corresponding VM 122. Such a virtual hardware platform includes emulated hardware such as vCPUs 136 and guest physical memory. Additional vCPUs 138 execute various tasks including the deletion of snapshots.

According to embodiments, upon determining an ideal duration for deleting a snapshot, snapshot module 126 executes a background process on vCPUs 138 to delete the snapshot over the ideal duration. The background process updates items of snapshot metadata 128 for exclusively owned data blocks 154 of the snapshot, including mapping entries 130 corresponding to data blocks 154, over the ideal duration. The process does so by alternately transmitting IOs for processing the deletion and idling to yield usage of CPU(s) 142 to other processes. More specifically, the process alternately transmits IOs for processing the deletion and yields usage of CPU(s) 142 in such a manner as to ensure that the deletion is completed over the ideal duration, which is fast enough to free up storage space efficiently but also slow enough to avoid causing traffic burst.

Shared storage 150 is a storage device that stores data blocks 154 of virtual disks of VMs 122. Shared storage 150 further includes a storage controller 152 for handling IOs issued to the virtual disks by VMs 122. In the embodiment depicted in FIG. 1, shared storage 150 is, e.g., network-attached storage (NAS) that is accessible to hosts 110 through corresponding NICs 148. However, shared storage 150 may also be a storage array that each host 110 accesses by using a host bus adapter (HBA) (not shown) to communicate over a fibre channel (not shown). Shared storage 150 may also be a virtual storage area network (vSAN) device that is aggregated and provisioned from local storage 146 of hosts 110.

Virtualization manager 160 communicates with hosts 110 via a management network (not shown), which may be provisioned from physical network 102. Virtualization manager 160 performs administrative tasks such as managing hosts 110, provisioning and managing VMs 122, migrating VMs 122 between hosts 110, and load balancing between hosts 110. Virtualization manager 160 may be a VM 122 executing in one of hosts 110 or a computer program that resides and executes in a separate server. One example of virtualization manager 160 is the VMware vCenter Server® by VMware, Inc. Virtualization manager 160 includes a snapshot manager 162 for generating instructions such as to create, delete, or revert to snapshots of shared storage 150. Snapshot manager 162 transmits such instructions to snapshot module 126 via the management network.

Although FIG. 1 illustrates hosts 110 accessing shared storage 150, in other embodiments, hosts 110 may separately store snapshots and running points of virtual disks in respective local storage 146. Additionally, although FIG. 1 illustrates virtualized computer system 100, other embodiments include non virtualized computer systems in which snapshots and running points are managed for files.

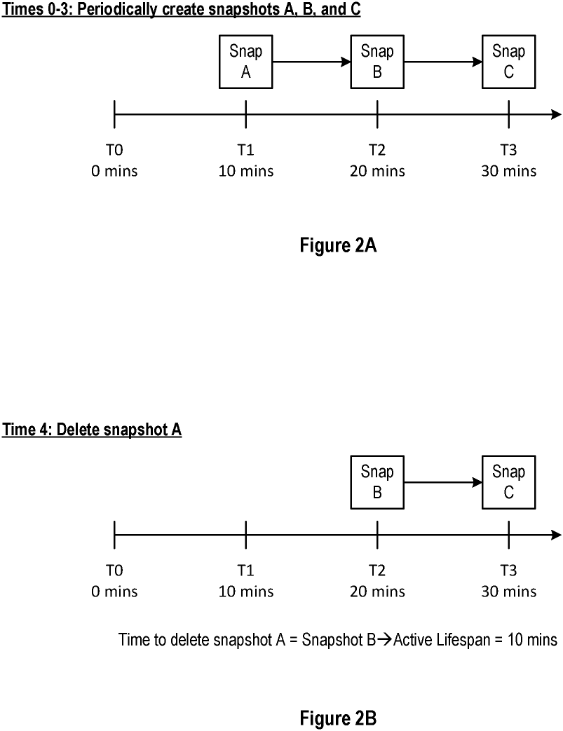

FIGS. 2A-2B illustrate a timeline of periodically creating snapshots of a virtual disk and deleting a snapshot. In the example of FIG. 2A, snapshots are periodically created every ten minutes. Starting at a time 0, after ten minutes elapse, a first snapshot “A” is created at a time 1 from a first running point (not shown). After another ten minutes elapse after time 1, a second snapshot “B” is created at a time 2 from a second running point (not shown), and after another ten minutes elapse after time 2, a third snapshot “C” is created at a time 3 from a third running point (not shown). As such, in the example of FIG. 2A, snapshots A. B, and C each have active lifespans often minutes. Specifically, snapshot A has an active lifespan of ten minutes because it was the first running point from time 0 (zero minutes) to time 1 (ten minutes), snapshot B has an active lifespan of ten minutes because it was the second running point from time 1 (ten minutes) to time 2 (twenty minutes), and snapshot C has an active lifespan of ten minutes because it was the third running point from time 2 (twenty minutes) to time 3 (thirty minutes). Accordingly, after snapshots A. B, and C are created, corresponding active lifespan variables 132 each store the value ten minutes.

FIG. 2B illustrates a time 4 at which snapshot manager 162 has targeted snapshot A for deletion. To determine the ideal duration for deleting snapshot A, snapshot module 126 reads active lifespan variable 132 corresponding to snapshot B, which is the child snapshot of snapshot A. Because active lifespan variable 132 stores the value ten minutes, snapshot module 126 determines that the ideal duration for deleting snapshot A is, e.g., approximately ten minutes.

FIGS. 3A-3C illustrate a timeline of creating snapshots of a virtual disk ad hoc and deleting snapshots. In the example of FIG. 3A, snapshots are created at irregular intervals. Starting at a time 0, after five minutes elapse, a first snapshot “D” is created at a time 1 from a first running point (not shown). After another twenty minutes elapse after time 1, a second snapshot “E” is created at a time 2 from a second running point (not shown). After another six minutes elapse after time 2, a third snapshot “F” is created at a time 3 from a third running point (not shown), and after another nine minutes elapse after time 3, a fourth snapshot “G” is created at a time 4 from a fourth running point (not shown). Accordingly, in the example of FIG. 3A, snapshots D, E, F, and G have varying active lifespans.

Snapshot D has an active lifespan of five minutes because it was the first running point from time 0 (zero minutes) to time 1 (five minutes), snapshot E has an active lifespan of twenty minutes because it was the second running point from time 1 (five minutes) to time 2 (twenty-five minutes), snapshot F has an active lifespan of six minutes because it was the third running point from time 2 (twenty-five minutes) to time 3 (thirty-one minutes), and snapshot G has an active lifespan of nine minutes because it was the fourth running point from time 3 (thirty-one minutes) to time 4 (forty minutes). As such, after snapshots D, E, F, and G are created, corresponding active lifespan variables 132 store the values five, twenty, six, and nine minutes, respectively.

FIG. 3B illustrates a time 5 at which snapshot manager 162 has targeted snapshot E for deletion. To determine the ideal duration for deleting snapshot E, snapshot module 126 reads active lifespan variable 132 corresponding to snapshot F, which is the child snapshot of snapshot E. Because active lifespan variable 132 stores the value six minutes, snapshot module 126 determines that the ideal duration for deleting snapshot E is, e.g., approximately six minutes.

Furthermore, because snapshot F has a shorter active lifespan (six minutes) than that of snapshot E (twenty minutes), snapshot module 126 updates active lifespan variable 132 corresponding to snapshot F from six minutes to twenty minutes. This is necessary because there were twenty minutes from time 1 to time 2 during which VM 122 could transmit overwrite requests targeting data blocks 154 owned by snapshot D, i.e., twenty minutes for various data blocks 154 owned by snapshot D to become exclusively owned. As such, after the deletion of snapshot E, if snapshot manager 162 targets snapshot D for deletion, snapshot module 126 should determine the ideal duration of the deletion based on the value twenty minutes. Snapshot module 126 should not determine the duration based on the six-minute interval during which snapshot F, the new child snapshot of snapshot D, was the running point. Basing the duration on the six-minute interval would likely result in traffic burst.

FIG. 3C illustrates a time 6 at which snapshot manager 162 has targeted snapshot D for deletion. To determine the ideal duration for deleting snapshot D, snapshot module 126 reads active lifespan variable 132 corresponding to snapshot F. Because active lifespan variable 132 now stores the value twenty minutes, snapshot module 126 determines that the ideal duration for deleting snapshot D is, e.g., approximately twenty minutes.

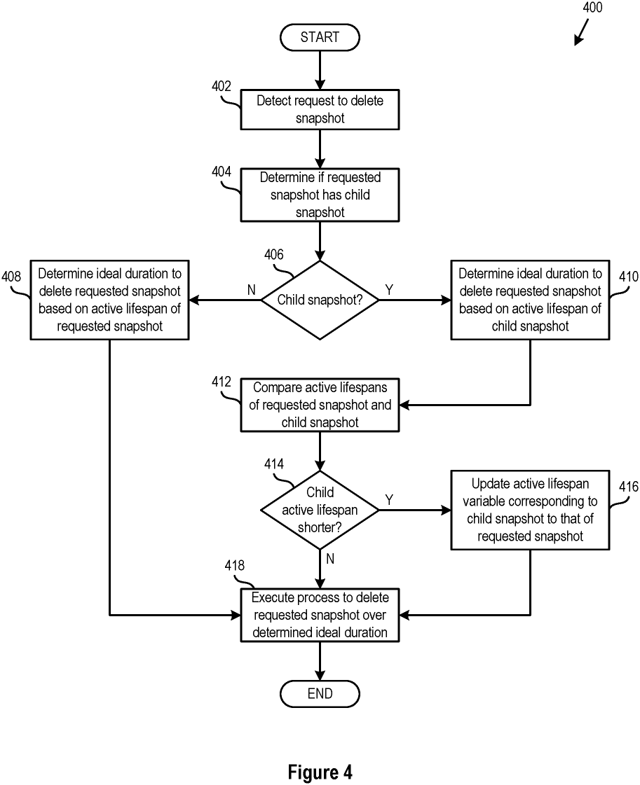

FIG. 4 is a flow diagram of steps carried out by snapshot module 126 to carry out a method 400 of deleting a snapshot of a virtual disk based on a determined duration, according to an embodiment. At step 402, snapshot module 126 detects a request from snapshot manager 162 to delete a snapshot. For example, an administrator of virtualization manager 160 may direct the request or snapshot manager 162 may generate the request automatically. At step 404, snapshot module 126 determines if the requested snapshot has a child snapshot by checking snapshot metadata 128 corresponding to the requested snapshot. At step 406, if the requested snapshot does not have a child snapshot, method 400 moves to step 408.

At step 408, snapshot module 126 determines the ideal duration to delete the requested snapshot based on active lifespan variable 132 corresponding to the requested snapshot. For example, snapshot module 126 may determine the ideal duration to be exactly or approximately equal to active lifespan variable 132. Given that the requested snapshot does not have a child snapshot, e.g., because each of its child snapshots have been deleted, all data blocks 154 owned by the requested snapshot are exclusively owned data blocks. In this case, basing the ideal duration on the active lifespan of the requested snapshot frees storage space without creating traffic burst. The longer the requested snapshot was the running point, the more time there was for data blocks 154 that are now exclusively owned by the requested snapshot, to be allocated to the virtual disk, while the shorter the requested snapshot was the running point, the less time there was for such allocations.

Returning to step 406, if the requested snapshot has a child snapshot, method 400 moves to step 410. At step 410, snapshot module 126 determines the ideal duration to delete the requested snapshot based on active lifespan variable 132 corresponding to the child snapshot of the requested snapshot. For example, snapshot module 126 may determine the ideal duration to be exactly or approximately equal to active lifespan variable 132. In this case, basing the duration on the active lifespan of the child snapshot is ideal for freeing storage space without creating traffic burst. The longer the child snapshot was the running point, the more time there was for data blocks 154 owned by the requested snapshot to become exclusively owned due to overwrite requests from VM 122, while the shorter the child snapshot was the running point, the less time there was for such overwrite requests.

At step 412, snapshot module 126 compares active lifespan variables 132 corresponding to the requested snapshot and the child snapshot. At step 414, if the child snapshot has a shorter active lifespan than that of the requested snapshot, as indicated by respective active lifespan variables 132, method 400 moves to step 416. At step 416 snapshot module 126 updates active lifespan variable 132 corresponding to the child snapshot to that of the requested snapshot. In this case, as discussed above in conjunction with FIG. 3B, after the deletion of the currently requested snapshot, snapshot manager 162 may target a parent snapshot of the currently requested snapshot, for deletion. Accordingly, to avoid traffic burst, snapshot module 126 should determine the ideal duration for deleting the parent snapshot based on the active lifespan of the currently requested snapshot, not the shorter active lifespan of the child snapshot of the currently requested snapshot.

Returning to step 414, if the child snapshot of the requested snapshot does not have a shorter active lifespan than that of the requested snapshot, method 400 moves directly to step 418. At step 418, snapshot module 126 executes a background process to delete the requested snapshot over the ideal duration determined at one of steps 408 and 410. The background process deletes the requested snapshot by alternately transmitting IOs to update various items of snapshot metadata 128 corresponding to data blocks 154 exclusively owned by the requested snapshot, and idling to yield usage of CPU(s) 142 to other processes. The background process alternates in such a manner as to ensure that the deletion is completed over the determined ideal duration. After step 418, method 400 ends. If the requested snapshot had a parent snapshot, snapshot module 126 designates the parent snapshot of the requested snapshot as the parent snapshot of the child snapshot of the requested snapshot by updating corresponding snapshot metadata 128.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data that can thereafter be input into a computer system. Computer readable media may be based on any existing or subsequently developed technology that embodies computer programs in a manner that enables a computer to read the programs. Examples of computer readable media are HDDs, SSDs, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest operating system (OS) that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of managing storage space of a storage device, wherein the storage device includes a plurality of snapshots of a file, the method comprising:
in response to a request to delete a first snapshot, determining a first amount of time that elapsed between a creation of the first snapshot and a creation of a second snapshot that is a child snapshot of the first snapshot; and
after determining the first amount of time, executing a first process to delete the first snapshot over a first time interval, wherein the first time interval is based on the first amount of time.

2. The method of claim 1, wherein the deletion of the first snapshot comprises an updating of metadata of data blocks that are owned by the first snapshot and that are unshared with the second snapshot, and the data blocks were allocated to the file after a creation of a third snapshot that is a parent snapshot of the first snapshot but before the creation of the first snapshot.

3. The method of claim 2, wherein the file is a virtual disk of a virtual machine (VM).

4. The method of claim 3, wherein the metadata of the data blocks includes mappings between addresses of virtual blocks in a virtual storage space of the VM and physical addresses of the data blocks in the storage device.

5. The method of claim 2, wherein
executing the first process to delete the first snapshot over the first time interval includes alternately transmitting input/output operations (IOs) required to process the deletion and idling to yield processor usage to other processes.

6. The method of claim 2, further comprising:
after determining the first amount of time, determining a second amount of time that elapsed between the creation of the third snapshot and the creation of the first snapshot;
comparing the first amount of time to the second amount of time; and
in response to the first amount of time being shorter than the second amount of time, storing the second amount of time in a variable corresponding to the second snapshot.

7. The method of claim 6, further comprising:
after storing the second amount of time in the variable corresponding to the second snapshot, and in response to a request to delete the third snapshot, executing a second process to delete the third snapshot over a second time interval, wherein the request to delete the third snapshot is received after the request to delete the first snapshot, and the second time interval is based on the second amount of time.

8. A non-transitory computer readable medium comprising instructions that are executable in a computer system, wherein the instructions when executed cause the computer system to carry out a method of managing storage space of a storage device, and the storage device includes a plurality of snapshots of a file, the method comprising:
in response to a request to delete a first snapshot, determining a first amount of time that elapsed between a creation of the first snapshot and a creation of a second snapshot that is a child snapshot of the first snapshot; and
after determining the first amount of time, executing a first process to delete the first snapshot over a first time interval, wherein the first time interval is based on the first amount of time.

9. The non-transitory computer readable medium of claim 8, wherein the deletion of the first snapshot comprises an updating of metadata of data blocks that are owned by the first snapshot and that are unshared with the second snapshot, and the data blocks were allocated to the file after a creation of a third snapshot that is a parent snapshot of the first snapshot but before the creation of the first snapshot.

10. The non-transitory computer readable medium of claim 9, wherein the file is a virtual disk of a virtual machine (VM).

11. The non-transitory computer readable medium of claim 10, wherein the metadata of the data blocks includes mappings between addresses of virtual blocks in a virtual storage space of the VM and physical addresses of the data blocks in the storage device.

12. The non-transitory computer readable medium of claim 9, wherein executing the first process to delete the first snapshot over the first time interval includes alternately transmitting input/output operations (IOs) required to process the deletion and idling to yield processor usage to other processes.

13. The non-transitory computer readable medium of claim 9, the method further comprising:
after determining the first amount of time, determining a second amount of time that elapsed between the creation of the third snapshot and the creation of the first snapshot;
comparing the first amount of time to the second amount of time; and
in response to the first amount of time being shorter than the second amount of time, storing the second amount of time in a variable corresponding to the second snapshot.

14. The non-transitory computer readable medium of claim 13, the method further comprising:
after storing the second amount of time in the variable corresponding to the second snapshot, and in response to a request to delete the third snapshot, executing a second process to delete the third snapshot over a second time interval, wherein the request to delete the third snapshot is received after the request to delete the first snapshot, and the second time interval is based on the second amount of time.

15. A computer system comprising:
a storage device including a plurality of snapshots of a file; and
a host computing device including a software entity configured to:
in response to a request to delete a first snapshot, determine a first amount of time that elapsed between a creation of the first snapshot and a creation of a second snapshot that is a child snapshot of the first snapshot, and
after determining the first amount of time, execute a first process to delete the first snapshot over a first time interval, wherein the first time interval is based on the first amount of time.

16. The computer system of claim 15, wherein the deletion of the first snapshot comprises an updating of metadata of data blocks that are owned by the first snapshot and that are unshared with the second snapshot, and the data blocks were allocated to the file after a creation of a third snapshot that is a parent snapshot of the first snapshot but before the creation of the first snapshot.

17. The computer system of claim 16, wherein the file is a virtual disk of a virtual machine (VM).

18. The computer system of claim 17, wherein the metadata of the data blocks includes mappings between addresses of virtual blocks in a virtual storage space of the VM and physical addresses of the data blocks in the storage device.

19. The computer system of claim 16, wherein executing the first process to delete the first snapshot over the first time interval includes alternately transmitting input/output operations (IOs) required to process the deletion and idling to yield processor usage to other processes.

20. The computer system of claim 16, wherein the software entity is further configured to:
after determining the first amount of time, determine a second amount of time that elapsed between the creation of the third snapshot and the creation of the first snapshot,
compare the first amount of time to the second amount of time,
in response to the first amount of time being shorter than the second amount of time, store the second amount of time in a variable corresponding to the second snapshot, and
after storing the second amount of time in the variable corresponding to the second snapshot, and in response to a request to delete the third snapshot, execute a second process to delete the third snapshot over a second time interval, wherein the request to delete the third snapshot is received after the request to delete the first snapshot, and the second time interval is based on the second amount of time.
